(19) United States
(12) Patent Application Publication
(10) Pub. No.: US 2003/0210758 A1
(43) Pub. Date: Nov. 13, 2003

(54) Recovered clock generator with high phase resolution and recovered clock generating method

(75) Inventors: Chao-Cheng Lee, ChungLi (TW); Pao-Cheng Chiu, HsinTien City (TW)

Correspondence Address: BRUCE H. TROXELL, SUITE 1404, 5205 LEESBURG PIKE, FALLS CHURCH, VA, 22041, US

(73) Assignee: Realtek Semiconductor Corp.

(21) Appl. No.: 10/424,863

(22) Filed: Apr. 29, 2003

(30) Foreign Application Priority Data
Apr. 30, 2002 (TW) 91109182

(51) Int. Cl. H04L 7/00; H04L 25/00

(52) U.S. Cl. 375/371

(57) ABSTRACT

The present invention generally relates to a generator and a method for generating a recovered clock with high phase resolution. The recovered clock generator comprises a multi-phase clock generator to generate a plurality of multi-phase clock signals with a predetermined frequency higher than a target frequency; a phase selector for receiving the multi-phase clock signals and outputting a selected-phase clock signal according to a selecting signal; and a frequency divider for dividing the frequency of the selected-phase clock signal so as to generate a recovered clock with the target frequency. The recovered clock generator further comprises a phase interpolation unit between the multi-phase clock generator and phase selector. Therefore, the recovered clock generator of the invention can be implemented with less circuit space, and the wires of the layout will not interference the accuracy and the monotonic of the selected clock.

### BACKGROUND OF THE INVENTION

1. Field of the Invention

The present invention generally relates to a generator and a method for generating a recovered clock with high phase resolution, and more particularly to a generating method of recovered clock that employs the frequency dividing technology to reduce the layout space of the generator.

2. Description of the Prior Art

In general, a signal receiver transforms the analog signals being received to digital signals with an Analog Digital Converter (ADC). The phase information of the received signals can be obtained by processing the digital signals with a Digital Signal Processor (DSP). The phase controlling signal therefore can be generated by DSP and be fed back to the recovered clock generator to switch the recovered clock (sampling clock) to the best phase. FIG. 1 illustrates a schematic diagram showing a signal receiver employing a recovered clock provided by a conventional recovered clock generator to sample signals. As shown in FIG. 1, the signal receiver comprises a recovered clock generator 11, an ADC 12 and a DSP 13. The recovered clock generator 11 employs the phase control signal generated by the DSP 13 to provide precise recovered clock for the ADC 12. As shown in FIG. 2, when the recovered clock is right starting from a middle point between the received signals, the information transformed by the ADC 12 has highest accuracy and least error. Since the variation of the recovered clock is similar to the result of digitally quantifying the time (phase), it can be obtained that higher phase resolution will result in better phase accuracy and steadiness after processed by the feedback system.

Generally speaking, generators of multi-phase recovered clocks can be classified into two categories. One is the Multiple Phase Lock Loop and Delay Lock Loop, another one is the Phase Interpolation.

The conventional Multiple Phase Lock Loop shown in FIG. 7 is employing a multi-phase voltage-controlled oscillator to generate multiple phases distributing evenly in a single clock cycle, and the clock resolution thereof is limited by the minimum delay time of the Delay Cell. If the phase resolution needs to be increased, the delay time should be decreased, which will cause power loss and component size increase. Moreover, when the resolution is reaching as high as 32 or 64 phases every clock cycle, the wiring of the layout will interfere the accuracy and monotonic of the phase. Meanwhile, the Delay Lock Loop also encounters the same problem.

Phase Interpolation circuit can be an analog one or a digital one. The Analog Phase Interpolation circuit employs the weighting and the addition of analog cycle signals to fulfill its function, as shown in FIG. 8. That is, employing I/Q Quadrate Phase signal and control word to control V to I converter to add digital weighting electrically so as to generate a middle phase signal. The problem thereof is that the addition of digital weighting only approximates the ideal “middle” stage of a phase signal; it is hard to reach the best phase precisely. Moreover, the addition of digital weighting will cause different swings (amplitudes) in the middle stage of the phase signal. After being transformed to the full swing clock by the comparator 81, because the limitation of the limited gain of the comparator, the resolution and monotonic of phase signal will be interfered.

The Digital Phase Interpolation circuit employs some kind of Inverter circuit, as shown in FIG. 9. In a Digital Phase Interpolation circuit, the outputs of two Inverters 13 and 14 are connected, and two inputs of the Inverters are connected to the adjacent phase φA and φB. With alternate sequence of charging/discharging of the capacitor (not shown in the figure) of the output end, the middle phase φAB will be generated. Due to the architecture of circuit, the generation of multiple phase is increased by 2's exponent (2ⁿ) times, and so is the size of circuit. Therefore, the cost and the power consumption of the circuit is also in proportion to 2's exponent times. When implementing a high resolution phase circuit by using the Digital Phase Interpolation technique, such kind of high cost and power consumption becomes a major disadvantage of this prior art circuit. In addition, when the size of the circuit increases, the wiring of the layout will interfere the accuracy and monotonic of the phase as well.

### SUMMARY OF THE INVENTION

Accordingly, it is the primary object of the present invention to provide a generator and a method for generating a recovered clock with high phase resolution. The recovered clock generator of the invention can be implemented with less circuit space, and the wires of the layout will not interfere the accuracy and the monotonic of the phase signal.

To achieve the foregoing object, the recovered clock generator of the present invention comprises a multi-phase clock generator to generate a plurality of multi-phase clock signals with a predetermined frequency higher than a target frequency; a phase selector for receiving the multi-phase clock signals and outputting a selected-phase clock signal according to a selecting signal; and a frequency divider for dividing the frequency of the selected-phase clock signal output from the phase selector so as to generate the recovered clock with the target frequency.

In another preferred embodiment, the recovered clock generator further comprises a phase interpolation unit furnished between the multi-phase clock generator and phase selector. Such that the amount of the phases of the multi-phase clock signals output from the multi-phase clock generator can be decreased.

Therefore, the recovered clock generator of the present invention can be implemented with less circuit space, and the wires of the layout will not interference the accuracy and the monotonic of the phases.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits and advantages of the preferred embodiments of the present invention will be readily understood by the accompanying drawings and detailed descriptions, wherein:

FIG. 1 is a schematic diagram showing a conventional signal receiver employing recovered clock provided by a recovered clock generator to sample signal.

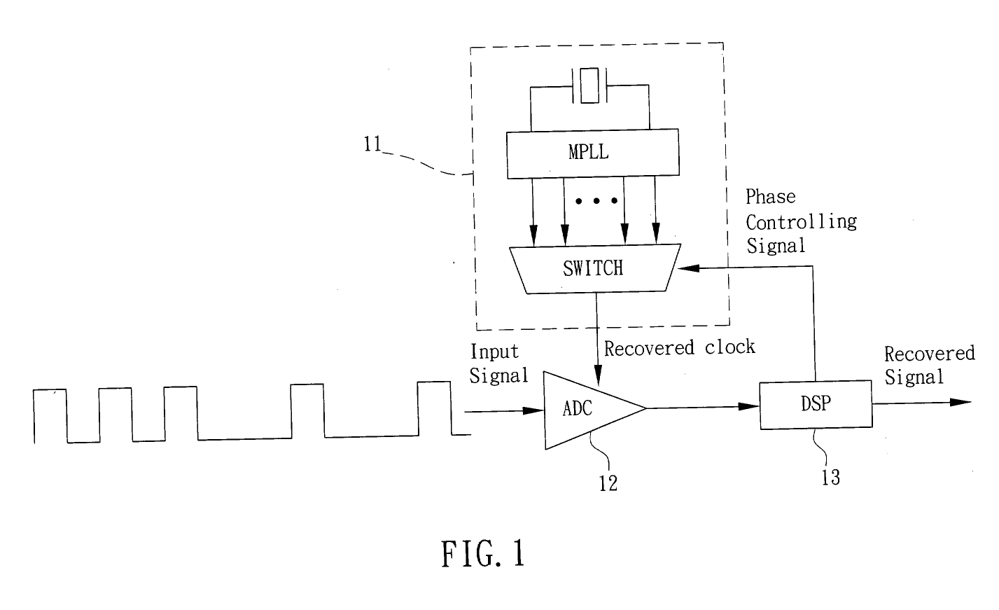

FIG. 2 is a diagram showing a recovered clock which is on the middle stage of the received signal.

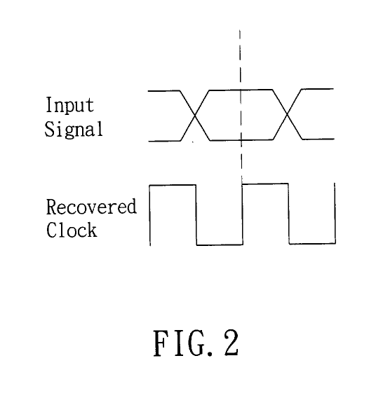

FIG. 3 is a schematic block diagram showing the first embodiment of the generator for generating a recovered clock with high phase resolution according to the present invention.

FIG. 4 is a diagram showing the application of the first embodiment of the generator according to the present invention.

FIG. 5 is a diagram showing the second embodiment of the generator for generating a recovered clock with high phase resolution according to the present invention.

FIG. 6 is a diagram showing the application of the second embodiment of the generator according to the present invention.

FIG. 7 is a diagram showing a conventional Multiple Phase Lock Loop.

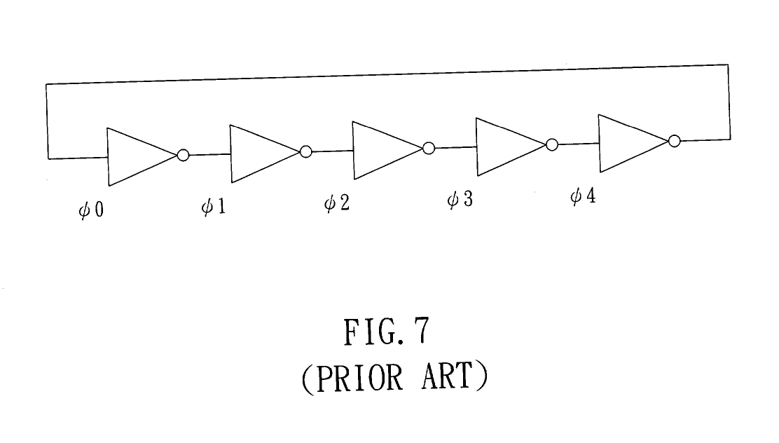

FIG. 8 is a diagram showing a prior art Analog Phase Interpolation circuit.

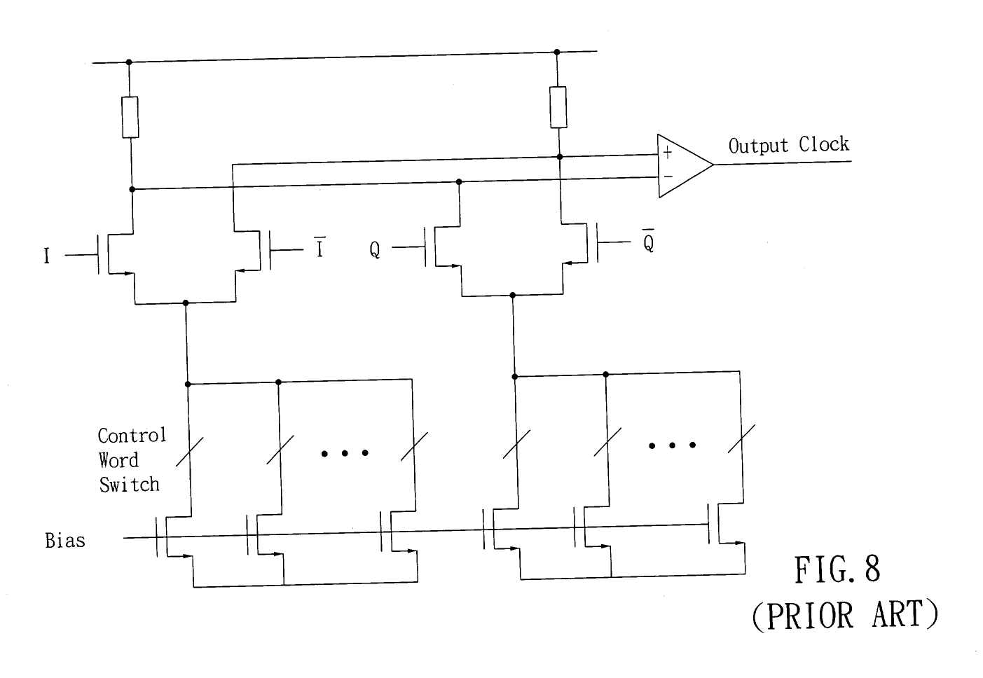

FIG. 9 is a diagram showing a prior art Digital Phase Interpolation circuit.

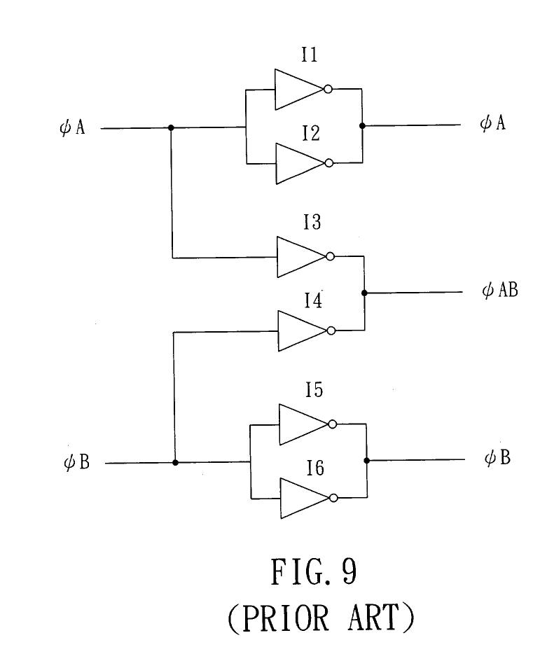

### DETAILED DESCRIPTION OF THE INVENTION

The present invention provides a generator and a method for generating a recovered clock with high phase resolution. Detailed description of the generator and the method can be exemplified by the preferred embodiments as described hereinafter.

The generator in accordance with the present invention employs the Phase Lock Loop (PLL) to work on a multiplied working frequency with less number of phases, and to switch the phases in advance before dividing the frequency back to the original frequency so as to meet the requirement of the recovered clock with lower frequency and high resolution. The circuit implemented with such solution will take less circuit space, and the wiring of the layout will not interfere the accuracy and the monotonic of the phase signals. Meanwhile, the present invention can also be embedded with the phase interpolation circuit to reduce the difficulty of design of the voltage-controlled oscillator, or to further increase the phase resolution.

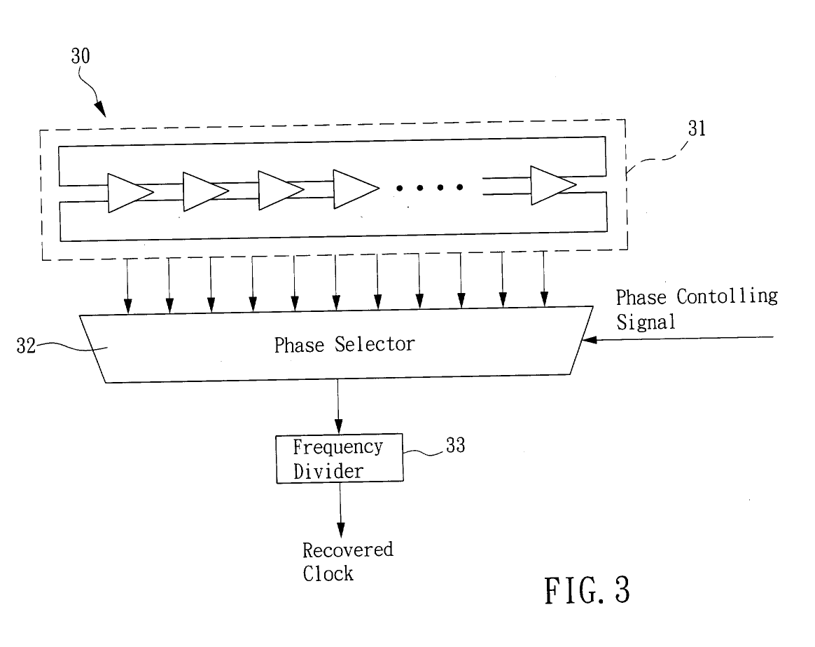

FIG. 3 is a schematic block diagram showing the first embodiment of the generator for generating a recovered clock with high phase resolution according to the present invention. As shown, the recovered clock generator 30 comprises a multi-phase voltage-controlled oscillator 31 (also referred as the multi-phase clock generator), a phase selector 32 and a frequency divider 33. Since the object of the recovered clock generator is to generate a recovered clock with a target frequency Fclk and a target resolution, the conventional way to achieve this object is to employ the multi-phase voltage-controlled oscillator to output a multi-phase clock signal with the same target frequency. The number of phases of the multi-phase clock signal generated by the voltage-controlled oscillator is depending on the target resolution. For example, to generate a multi-phase clock signal with 64 phases. In order to reduce the number of phases which the voltage-controlled oscillator has to generate but still meet the requirements of the target frequency and the target resolution of the recovered clock, the present invention adapts the method that multiplying the frequency first and then dividing the frequency back to the original value. That is, the multi-phase voltage-controlled oscillator 31 of present invention outputs a plurality of multi-phase clock signals with a predetermined frequency (also referred as working frequency) which is N times of the target frequency Fclk of the recovered clock. Since the working frequency of the multi-phase clock signals are increased, fewer phases will establish the same resolution. And then, the phase selector 32 receives the multi-phase clock signals and outputs a selected-phase clock signal according to a selecting signal. After that, the frequency divider 33 will divide the working frequency back to the target frequency Fclk of the recovered clock, which will meet the requirements for the recovered clock and the resolution.

Assuming the multi-phase voltage-controlled oscillator 31 generates a multi-phase clock signal with P phases and frequency N*Fclk, so, the resolution for each phase is Tclk/(N*P), wherein Tclk=1/Fclk. After being divided N times by the frequency divider 33, the frequency of the recovered clock is Fclk, which meets the requirements of the target frequency and the target resolution for the recovered clock but with fewer phases. That is, in comparison with the prior art, the multi-phase voltage-controlled oscillator 31 of the present invention only needs to generate a multi-phase clock signal with fewer phases in order to obtain a recovered clock with the same target frequency and target resolution. Thus, the circuit of the recovered clock generator 30 in accordance with the present invention is easier to implement. Such improvement made by the present invention not only requires less space for circuit layout but also the wiring of the layout will not interfere the accuracy and the monotonic of the phase signals.

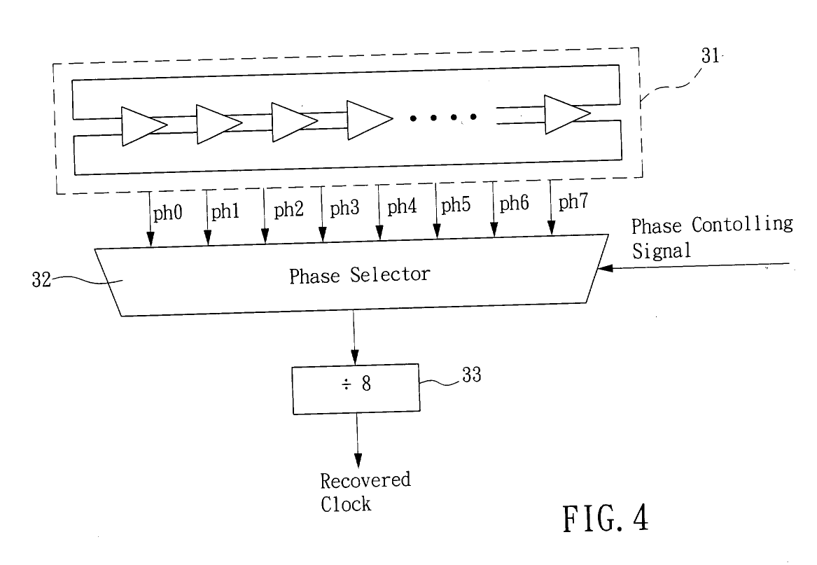

For example, if the requirement for a recovered clock is having a target frequency 125 MHz (Tclk=8 ns) and a target resolution 125 ps, a conventional multi-phase voltage-controlled oscillator of a conventional recovered clock generator will have to generate a multi-phase clock signal with 64 phases and 125 MHz frequency, such that the resolution will be 8 ns/64=125 ps. As shown in the FIG. 4, which is a diagram showing the first embodiment of the generator for generating a recovered clock with high phase resolution according to the present invention. Assuming both N and P are set to 8, then the oscillating frequency (i.e. the working frequency) of the multi-phase voltage-controlled oscillator 31 will be increased to 1000 MHz (i.e., eight times to the target frequency), and the multi-phase voltage-controlled oscillator 31 only outputs the multi-phase clock signals with 8 phases. So, the resolution for the multi-phase clock signal with 8 phases output from the multi-phase voltage-controlled oscillator 31 is 1 ns/8=125 ps, which still meets the requirement of the target resolution. After that, the phase selector 32 receives the multi-phase clock signals and outputs a selected-phase clock signal according to a selecting signal. The frequency divider 33 then divides the frequency of the selected-phase clock signal output from the phase selector 32 by 8 so as to generate a recovered clock with 125 MHz frequency. Although the oscillating frequency of the multi-phase voltage-controlled oscillator 31 increased, the amount of phases is reduced to 8, which extremely reduces the size and the complexity of the circuit.

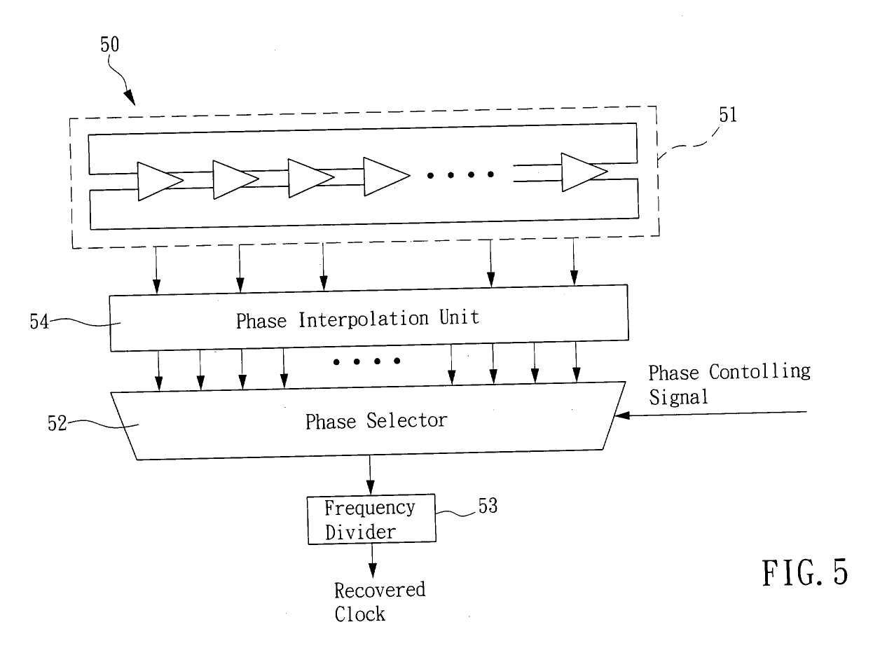

FIG. 5 is a diagram showing the second embodiment of the generator for generating a recovered clock with high phase resolution according to the present invention. As shown, the recovered clock generator 50 comprises a multi-phase voltage-controlled oscillator 51, a phase selector 52, a frequency divider 53 and a phase interpolation unit 54. In this embodiment, the phase interpolation unit 54 is added between the multi-phase voltage-controlled oscillator 51 and the phase selector 52. Therefore, the multi-phase voltage-controlled oscillator 51 in this embodiment will operate in a lower working frequency or to output fewer phases.

Assuming the multi-phase voltage-controlled oscillator 51 generates a multi-phase clock signal with P phases and frequency N*Fclk. So, after being processed by the phase interpolation unit 54, 2*P phases with frequency N*Fclk will be generated. Thereby, the resolution for each phase input to the phase selector 52 is Tclk/(N*2*P), wherein Tclk=1/Fclk. After being divided N times by the frequency divider 53, the frequency of the recovered clock is Fclk, which meet the requirements of the target frequency and the target resolution for the recovered clock but with fewer phases and is easy to implement. It also requires less space for circuit layout and the wiring of the layout will not interfere the accuracy and the monotonic of the phase signals.

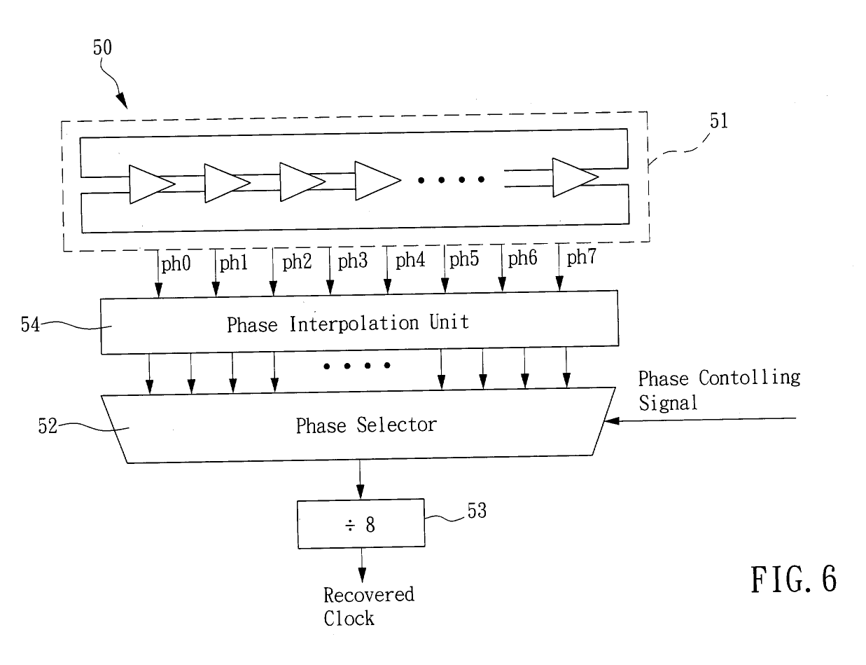

For example, if the requirement for a recovered clock is having a target frequency 125 MHz (Tclk=8 ns) and a target resolution 125 ps, a conventional multi-phase voltage-controlled oscillator of a conventional recovered clock generator will have to generate a multi-phase clock signal with 64 phases and 125 MHz frequency. The resolution thereof is 8 ns/64=125 ps. As shown in the FIG. 6, which is a diagram showing the second embodiment of the generator according to the present invention. Assuming N is set to 4 and P is set to 8, then the oscillating frequency (i.e. the working frequency) of the multi-phase voltage-controlled oscillator 51 will be increased to 500 MHz. And the multi-phase voltage-controlled oscillator 51 only outputs the multi-phase clock signals with 8 phases. After being processed by the phase interpolation unit 54, the multi-phase clock signals with 8 phases and 500 MHz frequency will become a plurality of new multi-phase clock signals with 16 phases and 500 MHz frequency. Therefore, the resolution for the multi-phase clock signals with 16 phases output from the phase interpolation unit 54 will be 2 ns/16=125 ps, which meets the requirement of the target resolution. The phase selector 52 then selects one of the phases to generate a selected-phase clock signal according to a selecting signal. After that, the frequency divider 53 further divides the selected-phase clock signal output from the phase selector 52 by 4 so as to generate the recovered clock of 125 MHz. Although the oscillating frequency of the multi-phase voltage-controlled oscillator 31 increased, the number of phases is reduced to 8, which extremely reduces the size and the complexity of the circuit.

Since the generator for generating a recovered clock with high phase resolution of the invention increases the working frequency of the voltage-controlled oscillator to meet the required target resolution with fewer phases, the space required for circuit layout is much reduced, and the wires of the layout will not interference the accuracy and the monotonic of the phase signals.

Although this invention has been disclosed and illustrated with reference to particular embodiments, the principles involved are susceptible for use in numerous other embodiments t hat w ill b e apparent to persons skilled in the art. This invention is, therefore, to be limited only as indicated by the scope of the appended claims.

What is claimed is:

1. A recovered clock generator, comprising:
a multi-phase clock generator for generating a plurality of multi-phase clock signals;
a phase selector for outputting a selected-phase clock signal from the multi-phase clock signals according to a selecting signal; and
a frequency divider for generating a recovered clock signal according to the selected-phase clock signal;
wherein the frequency of each of the multi-phase clock signals is higher than that of the recovered clock signal.

2. The recovered clock generator of claim 1, wherein the multi-phase clock generator is a multi-phase voltage-controlled oscillator.

3. The recovered clock generator of claim 1, further comprising a phase interpolation unit which is placed between the clock generator and the phase selector for multiplying the amount of the phases of the multi-phase clock signal output from the clock generator.

4. The recovered clock generator of claim 3, wherein the phase interpolator unit is a digital phase interpolator unit.

5. The recovered clock generator of claim 1, wherein the frequency of the selected-phase clock signal is equaled to the frequency of the recovered clock times an integral number.

6. A method for generating a recovered clock signal, comprising:
generating a plurality of multi-phase clock signals, wherein the frequency of each of the multi-phase clock signals is larger than that of the recovered clock signal;
selecting a selected-phase clock signal from the multi-phase clock signals according to a control signal; and
generating the recovered clock signal according to the selected-phase clock signal through frequency dividing.

7. The method of claim 6, wherein the frequency of the selected-phase clock signal is equaled to the frequency of the recovered clock times an integral number.

8. The method of claim 6, wherein the multi-phase clock signals are generated through phase interpolator.

9. A recovered clock generator, comprising:
a multi-phase clock generator for generating a plurality of multi-phase clock signals;
a phase interpolator unit for generating a plurality of interpolated multi-phase clock signals according to the multi-phase clock signals;
a phase selector for outputting a selected-phase clock signal from the interpolated multi-phase clock signals according to a selecting signal; and
a frequency divider for generating a recovered clock signal according to the selected-phase clock signal;
wherein the frequency of each of the interpolated multi-phase clock signals is higher than that of the recovered clock signal.

10. The recovered clock generator of claim 9, wherein the multi-phase clock generator is a multi-phase voltage-controlled oscillator.

11. The recovered clock generator of claim 9, wherein the phase interpolator unit is a digital phase interpolator unit.

12. The recovered clock generator of claim 9, wherein the frequency of the selected-phase clock signal is equaled to the frequency of the recovered clock times an integral number.
